(19) United States
(12) Patent Application Publication
(10) Pub. No.: US 2003/0220872 A1
(43) Pub. Date: Nov. 27, 2003

(54) System and method for controlling the acquisition of services

(76) Inventors: Uma Chandrashekhar, Morganville, NJ (US); Steven H. Richman, Marlboro, NJ (US); S. Rao Vasireddy, Holmdel, NJ (US); Chen Xie, Piscataway, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/155,768

(22) Filed: May 24, 2002

(51) Int. Cl. G06F 17/60

(52) U.S. Cl. 705/40

(57) ABSTRACT

A system for controlling the acquisition of services allows a subscriber, to add, delete, and/or modify a wide variety of services, e.g., telephone and multimedia services, from a single point of access via any interface technology. The services may be provided to the same point of access, or another point of access as requested by the subscriber. The services may be provided by a plurality of service providers. The system is technology independent, such that subscribers and service providers may access the system via any technology, e.g., wireless, wireline. Also, payments are consolidated, such that the subscriber receives a single bill for the provided services, and not individual bills from each service provider.

### FIELD OF THE INVENTION

The present invention is generally related to systems and methods for controlling the acquisition of applications and services, and more specifically related to automated systems and methods for controlling the acquisition of communications and media applications and services and modifying parameters associated with existing applications and services.

### BACKGROUND

Typically, service providers offer only a limited set of services to a user and the user must follow a rigid predetermined process to subscribe to a service. For example, a user may contact a first service provider to order telephone service, contact a second service provider to order cable television service, and contact a third service provider to order Internet access. This, disadvantagely, can be time consuming and costly for the user. Typically, the user must communicate with numerous people and/or machines, several times, to subscribe to, activate, and modify these services. In addition, this process usually requires the user to have some knowledge of the services being provided by each service provider to understand the set of services. A lack of such user knowledge can lead to additional time required to evaluate, receive, and use the service, leading to lost revenue opportunity for the service provider.

There are other disadvantages associated with this process. There is no automated prevention of overlap in services provided by the various service providers. There is no automatic assessment of compatibility of the user's equipment with the requested services. Also, the user must review each service provider's set of available services and associated costs to assess whether she has ordered the most cost-effective set of services. Web-based (accessed through the Internet) self-subscription services are currently available. However, these are typically restricted to a limited set of services, e.g., cable modem/DSL activation for high-speed Internet access, bill verification/payment. Thus, access to services is typically technology dependent, e.g., a user can subscribe to phone service only over the phone, can check billing statement only over the Internet. Typically, these services are not portable. For example, a user may order a movie to be shown at the user's home on a specific date. If the user is not home on that date, she can not view the movie.

### SUMMARY

In one embodiment, a system for controlling the acquisition of services allows a subscriber, to add, delete, and/or modify a wide variety of services, e.g., telephone and multimedia services, from a single point of access via any interface technology. The services may be provided to the same point of access, or another point of access as requested by the subscriber. The services may be provided by a plurality of service providers. The system is technology independent, such that subscribers and service providers may access the system via any technology, e.g., wireless, wireline.

The system and method include a customer relations manager portion comprising information indicative of a user profile, a supply chain manager portion comprising information indicative of available services; and an application engine for receiving a signal indicative of a request for at least one service comprising communication and media services and for processing the request in accordance with information contained in the supply chain manager portion and the customer relations manager portion.

### BRIEF DESCRIPTION OF THE DRAWINGS

Included in the drawings are the following figures:

FIG. 1 is a functional block diagram of an embodiment of a system for controlling the acquisition of services and applications, in accordance with the present invention;

FIG. 2 is an illustration of a system for controlling the acquisition of services and applications, in accordance with the present invention, showing exemplary communications interfaces and protocols;

FIG. 3 is an illustration of an exemplary system for controlling the acquisition of services and applications, in accordance with the present invention, showing various interface and media technologies;

FIG. 4 is a timing diagram depicting the timing relationships between events occurring in a process for controlling the acquisition of services and applications, in accordance with the present invention;

FIG. 5A is a flow diagram of an exemplary process for controlling the acquisition of applications and services, in accordance with the present invention;

FIG. 5B is a continuation of FIG. 5A; and

FIG. 6 is a table showing customization features including mandatory attributes and optional attributes in accordance with an exemplary embodiment of the invention.

### DETAILED DESCRIPTION

A system and method for controlling the acquisition of applications and services as described herein provides means for an end user (EU), such as a subscriber, to add, delete, and/or modify a wide variety of services, applications, e.g., telephone and multimedia services and applications, and/or associated attributes, from a single point of access, such as a personal computer (PC) coupled to a network. The services and applications may be provided to the same point of access, or another point of access as requested by the EU. The services and applications may be provided by a plurality of service providers (SPs) and/or application providers (APs). For example, an EU may, from her PC connected to the Internet, modify her existing telephone service profile to accept collect calls from selected telephone numbers during selected times, and also order movies to be provided at selected bandwidth and data rates, without having to communicate individually with each service/application provider, e.g., the telephone company and the cable company. Another example, applied to the health industry, is the scenario in which a roaming, on-call, radiologist desires to read a particular x-ray, but does not have the particular capability on her (personal digital assistant (PDA). However, based on a subscription service she has with the service provider or third-party, the radiologist can use the system and method for controlling the acquisition of the service allowing her to acquire the service to read the x-ray temporarily for the required duration with no knowledge of the PDA's capabilities and/or the vendor providing the service. Also, payments are consolidated, such that the EU receives a single bill for the provided services/applications, and not individual bills from each service/application provider.

To facilitate an understanding of the method and system described herein, a list of abbreviations and acronyms is provided in Table 1.

TABLE 1

| | |
|---|---|
| AE | Applications Exchange |
| AP | Application Provider |
| AR | Application Request |
| ASP | Application/Service Provider |
| ATM | Asynchronous Transfer Mode |
| CAMEL | Customized Applications Of Mobile Enhanced Logic |
| CLASS | Custom Local Area Signaling Service |
| CNM | Custom Network Management |
| CORBA ® | Common Object Request Broker Architecture |
| CPE | Customer Premises Equipment |
| CRM | Customer Relationship Management |
| DSL | Digital Subscriber Loop |
| EJB | Enterprise Javabeans |
| EJB/J2EE | Enterprise Javabeans/Java 2 Enterprise Edition |
| | Technology |
| EU | End Users |
| FR | Frame Relay |
| FTTH | Fiber To The Home |
| HTML | Hyper Text Markup Language |
| HTTP | Hypertext Transfer Protocol |
| ID | Identification Designation |
| IP | Internet Protocol |
| ISDN | Integrated Services Digital Network |
| ISP | Internet Service Provider |
| JSP | Java ® Server Pages |
| LDAP | Lightweight Directory Access Protocol |
| NOC | Network Operations Center |
| NOS | Network Operation Systems |
| ODBC/JDBC | Open Database Connectivity/Java ® Database |
| | Connectivity |
| OSA | Open Systems Architecture |
| OSS | Operation Support System |
| PC | Personal Computer |
| PDA | Personal Digital Assistant |
| PL | Private Line |
| QoS | Quality Of Service |
| SCM | Supply Chain Management |
| SP | Service Provider |
| SS7 | Signaling System 7 |
| SSS | Service Support Systems |
| UI | User Interface |
| VPN | Virtual Private Network |
| WAN | Wide Area Network |
| WASP | Wireless Application Service Provider |
| WIN | Wireless Intelligent Networking |
| XML | Extensible Markup Language |
| 2-W | 2-Wire |
| 3G | Third Generation |

The method and system for controlling the acquisition of services and applications, is collectively referred to as “applications exchange” throughout this description. As described herein, a service is a capability provided by a service provider (SP). Example services include virtual private networks (VPNs), Internet protocol (IP) connectivity, and basic dial tone. An application utilizes one or more services. Example applications include voice communication with others, multimedia, streaming media, e-mail, e-commerce, Web browsing, messaging, insurance related applications, medical related applications, and sales related applications. For example, basic voice service (provided via the public switched telephone network infrastructure) allows EUs to place and accept local and long distance calls. The basic voice service also enables EUs to subscribe to many other applications. Examples of such applications include call waiting, call forwarding, and call blocking. Internet protocol (IP) virtual private network (VPN) is another example of a service that enables applications, such as secure file transfer, video-conferencing, access to application service provider (ASP) applications, and any combination thereof. Also, as used herein, a provider of a service is referred to as a service provider (SP), a provider of an application is referred to an application provider (AP), and a provider of a service, application, or any combination thereof is referred to as an application/service provider (ASP).

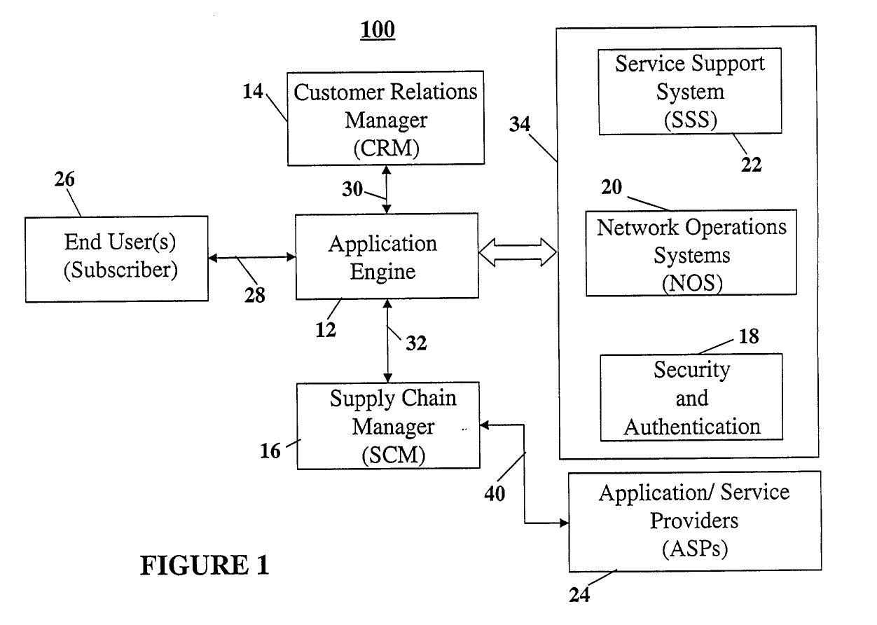

Referring now to FIG. 1, there is shown a functional block diagram of a system 100 for controlling the acquisition of services and/or applications. The system 100 comprises an application engine 12 for receiving and processing a signal 28 indicative of an application request (AR); a customer relations manager (CRM) portion 14 comprising end user profiles; and a supply chain manager (SCM) portion 16 comprising data related to available services/applications and respective attributes. The application request (AR) may be provided by any appropriate source, such as at least one end user (EU), as depicted by the end user portion 26. The application engine 12 receives the AR via signal 28 from the individual EUs. Each AR may comprise information pertaining to modification of an existing service/application, subscription to new services/applications, and deletion of services/applications, or any combination thereof. A new service/application may be new from the EU's perspective only, e.g., an existing service/application to which an EU has not previously subscribed. A new service/application may also be new from the perspective of the system 100, e.g., a service/application that was not previously available to any EU, such as a promotional service/application. The application engine 12 receives the AR via signal 28 and processes same by utilizing EU profile information contained in the CRM portion 14 and the application/service provider information contained in SCM portion 16 to determine if any services and/or applications available from the application/service provider portion 24 match the information in the AR.

EUs, e.g., subscribers, may choose to access various types of communications and information services/applications dependent upon any of several factors, such as personal preferences, willingness to pay, ease of use, access to services/applications, location-based and/or traditional service/application provider's offerings, and cultural factors. In the residential segment for example, services may include basic voice service, custom local area signaling service (CLASS) features, e.g., caller ID, call waiting, call blocking, and Internet access. Furthermore, these services/applications are available, to the EU, via a variety of technologies. For example, residential Internet access may be provided by a dialup/cable modem, digital subscriber loop (DSL), an integrated services digital network (ISDN), a wireless medium, or any combination thereof. Additionally, the use of wireless communications means may comprise the use of a personal digital assistant (PDA) and/or mobile phone/personal computer (PC) access key services. A system and method as described herein provides means for an EU to access the system 100 via any or all of the technologies described above to access any or all of the compatible services/applications described above.

The customer relations management (CRM) portion 14 comprises profile information of individual EUs. The profile information contained in the CRM 14 is representative of an EU's preferences and transactions with application/service providers. The profile information may be updated, by the EU and/or SP, dynamically in real time. A transaction results from a match between an EU's preferences and the available services/applications offered by the ASPs. A transaction comprises provision of a requested service/application and/or modification of a service/application to an EU, available from an ASP, via the system 100. A transaction may be a one-time occurrence, e.g., ordering a movie, or a recurring event, e.g., adding call forwarding. The CRM data may be distributed throughout the system 100 (which may include portions of the ASP's systems and/or databases), and need not necessarily be located in one physical entity. It is advantageous to provide secure access to the CRM 14 because of the nature of the information contained in the CRM 14. The CRM 14 may comprise information pertaining to the EU's preferences and information pertaining to the commercial value of the EU. Examples of the types of information which may be contained in the CRM 14 include EU profiles, EU specific reports, usage of specific services/applications, EU preferences such as communication, entertainment, education, customized view of business EUs, tag indicating the commercial value of the EU, helpful hints to support the EU, and customer care interfaces to the service/application providers. An example of data contained in the CRM 14 and associated databases may include: an EU identification designation (ID) comprising authentication/login information; the current amount of spending with each service/application provider; current services/application being used by the EU; newly requested services/applications; types of equipment currently being used by an EU, e.g., descrambler, digital cable decoder; and various EU preferences, e.g., preference for sports media, preference for wireless communications means.

The information contained in the CRM 14 may be advantageously utilized by application/service providers (ASPs). The system and method as described herein provide a relatively easy means for authorized ASPs to gain access to an EU's profile via the CRM 24. This may result in revenue for the ASP. Utilizing the information contained in the CRM 14, an ASP may identify profitable customers, update sales forecasts, determine cost and return of specific new markets, or any combination thereof. An authorized ASP may allow third-party vendors access to information contained in the CRM 14. For example, an ASP may provide access to portions of the information contained in the CRM 14 to a third party vendor to facilitate a market analysis of trial services/applications. This is advantageous to the third party vendor and the ASP because software resident at a vendor/provider's site is not required.

The supply chain manager (SCM) portion 16 comprises information pertaining to available services/applications. The information contained in the SCM 16 is representative of services/applications available to an EU, such as existing services/applications, new services/applications, and/or temporary services/applications, e.g., promotional. The information contained in the SCM portion 16 may be provided and/or accessed by an SP, an AP, a third party vendor, or any combination thereof via signal 40. Signal 40 is indicative of attributes associated with services/applications and ASPs. The information contained in the SCM portion 16 may be updated dynamically and/or periodically, in accordance with an ASP's requirements and capabilities. The time dependency of updates to the information contained in the SCM portion 16 is also a function of an ASP's network capabilities and the ability of an ASP to provide a service/application in time to meet an EU's requirements. For example, an existing SP may sell a specific service to a new SP having a network with a higher bandwidth than the existing SP. Furthermore, the new SP may offer additional services not previously available. Thus, the information in the SCM portion 16, will be updated to indicate the increased bandwidth capability of the new SP and the additional services offered by the new SP. Examples of the types of information contained in the SCM portion 16 may include: an identification designation (ID) comprising authentication information pertaining to an ASP; available services/applications; time an EU must wait before requesting a service/application and receipt of same; targeted market segment, e.g., age group, associated with a service/application, EU attributes; equipment required by an EU to receive service/application; other ASPs providing a service/application; access restrictions; available options; security restrictions, e.g., based on vertical industry segments, such as insurance, medical, entertainment; level of service options; and payment options/rates/tariffs.

The application engine 12 compares the information contained in the application request (AR) with the information contained in the CRM portion 14 (EU profiles) and the information contained in the SCM portion 16 (services/applications/ASP profiles) via signals 30 and 32, respectively. Signal 30 comprises information indicative of the AR and the EU's profile contained in CRM portion 14. Signal 32 comprises information indicative of the AR, the available services/applications, and ASPs, contained in SCM portion 16. An EU's network topology and customer premises equipment (CPE), e.g., equipment an EU has at her premises, is made accessible to the CRM portion 14 by the system 100. EU network topology and CPE data may be provided by an ASP for existing customers and/or accumulated during processing of an AR. If the comparison results in a match between information contained in the AR, information contained in the CRM portion 14, and information contained in the SCM portion 16, an offer for a subscription is provided to the EU. If the EU decides to subscribe (accept the offer), the system 100 provides information, e.g., billing, available options, to the EU via application engine 12 to complete the subscription process. The system 100 also provides the information to the appropriate ASP(s) to facilitate provision of the requested services/applications.

The system 100 may also perform additional functions as indicated by processing portion 34, which may comprise a security and authentication portion 18, a network operations systems (NOS) portion 20, and a service support system (SSS) portion 22. Authentication, e.g., during login, of EUs and ASPs is accomplished by the security and authentication portion 18. An EU's ability to access and modify information, and the ability of ASPs to access other ASP's information, are determined in accordance with predetermined privilege and security levels.

The network operations systems (NOS) portion 20 facilitates the configuration of the system 100 to accommodate the processing of an AR and provide requested services/applications. The system 100 provides information related to requested services/applications to the NOS portion 20, to facilitate the AR being translated into network configuration information. Thus, the NOS portion 20 ensures that various elements of the system 100, required to provide a selected service/application to an EU, are in communication with each other.

The service support system (SSS) portion 22 may optionally provide various support systems and interface means needed to translate the ARs from system 100 and provide this information as input to the services/applications configuration and activation. For example, the SSS portion 22 translates the AR and provides the information to downstream policy engines, databases, authentication servers/databases and call/session control elements, as required by the service.

The system and method described herein provides an integrated approach for controlling the acquisition of services and applications utilizing various technologies and industry standards. The elements, e.g., elements 12, 14, 16, 26, and 34 of FIG. 1 of the system 100 may be in communication with each other, and between the EU and ASP, via various types of interfaces and protocols, which may be modified dynamically. No one type of interface/protocol is required for a communication path between elements. The communication paths may comprise wireless and/or wireline technology. Interface/protocols may include open, standards-based protocols such as lightweight directory access protocol (LDAP), common object request broker architecture (CORBA®) and non-proprietary enabling technologies such as Java® and CORBA®. In one embodiment, the system 100 is Web-based. A Web-based system provides means for access to the system 100 via a Web browser, e.g., Netscape®, Internet Explorer®. A Web-based system also provides means for software such as Java® server page and Extensible Markup Language (XML) to be used to provide dynamic Web content to EUs. For example, an EU may utilize XML to subscribe to services/applications through various devices such as a desktop PC, a PDA, or a third generation (3G) phone.

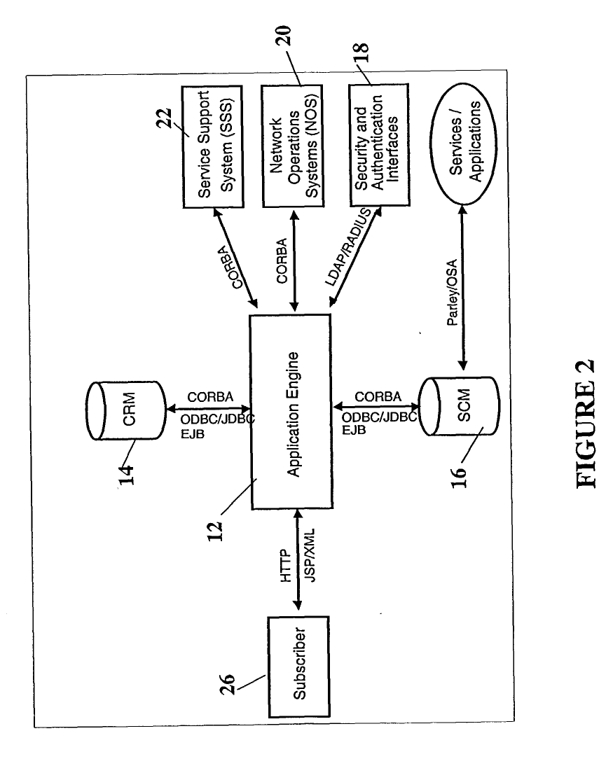

FIG. 2 is an illustration of the system 100 showing exemplary communications interfaces and protocols. In a Web-based system, CORBA® or other appropriate remote method invocation technology may be utilized to facilitate distributed communication between the elements of the system. A Radius or LDAP server may be utilized to provide a communications means to security and authentication portion 18 for subscribers (EUs) to be authenticated and authorized. Communication paths to the CRM portion 14 and the SCM portion 16 may be implemented using Enterprise JavaBeans®/Java 2 Enterprise Edition (EJB/J2EE) technology. In addition, the CRM portion 14 and the SCM portion 16 may utilize Open Database Connectivity/Java® Database Connectivity (ODBC/JDBC) to query the database within these elements to receive user profile information and application profile parameters. To facilitate deployment of new applications/services by a third party, open standard Parley/OSA gateway may be utilized. Parley/OSA provide standardized, extensible, scalable, and technology-independent application programming interfaces (APIs), allowing applications and services to make use of network functionality. Thus, utilizing Parley/OSA gateway for the communication path to ASPs and third parties, provides means for new applications and services the capability to access system in a technology independent manner. An EU may access the system 100 via various means. For example, an EU may access the system 100 via the Internet, through access means provides by an ASP, e.g., direct modem, voice over phone, or any combination thereof. An EU may be connected to a SP via any wireless or wireline technology. Because the system 100 is not in the direct communication path between an EU and an ASP, the EU's customer premises equipment (CPE) and access technology does not affect the system's ability to provide the intended functionality, e.g., requested services/applications. It is also understood that the SSS portion 22 may be concurrently communicating with other support infrastructure, such as intelligent networks. Configuration of the system 100 elements may be accomplished by an appropriate operation support system(s) (OSS) utilizing technologies such as customized applications of mobile enhanced logic (CAMEL), wireless intelligent networking (WIN), intelligent networks, policy engines, and/or other appropriate service enablers.

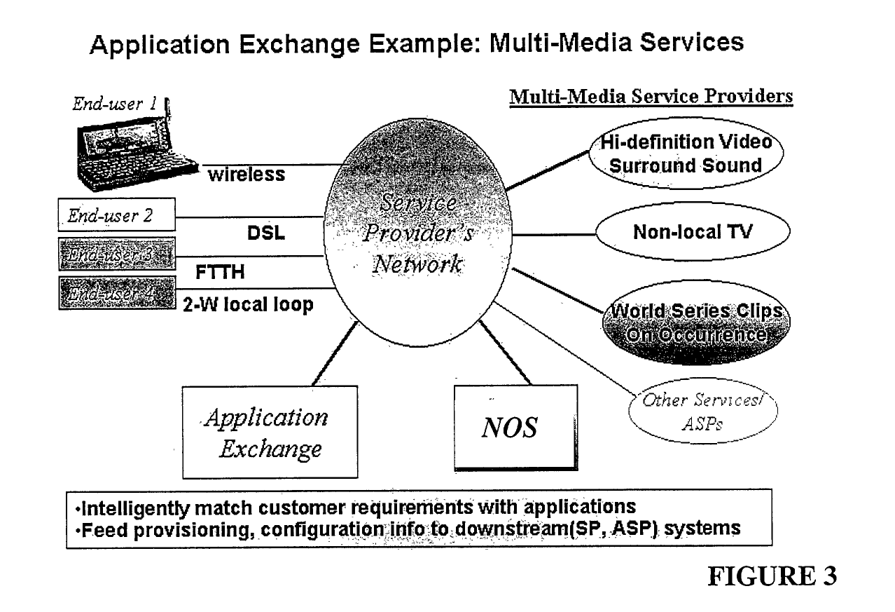

FIG. 3 is an illustration of an exemplary system for controlling the acquisition of services and applications showing various interface and media technologies. The system of FIG. 3 is depicted from a service provider-centric view. As shown, various ASPs may offer archived sports events, such as multimedia applications of broadcast TV, and streaming video. An EU may browse through the list of services/applications and specify the service/application to be provided. The access technology may vary from EU to EU. Example access technologies, as shown in FIG. 3, may include a 2-wire (2-W) subscriber loop, DSL, fiber to the home (FTTH), and wireless, for example. When an EU requests an application, such as high-definition video with surround sound, the system compares the requested application's characteristics (such as high bandwidth and low delay) with the EU's access profile, e.g., stored in the CRM portion 14 and the SCM portion 16 of system 100, to determine if the request is compatible with the access arrangement. The EU need not be knowledgeable of specific network characteristics to use the system. Most of the processing is transparent to the EU. For example, the system is configured to “know” that high-definition video cannot be transmitted over a 2-W subscriber loop. Thus, if the EU is accessing the system via a 2-W subscriber link and requests high definition video, the EU is notified that the request and the EU equipment are incompatible. However, if a match is found, and parameters are compatible, the EU is provided the results of the comparison and payment options are provided. Payment options may include credit card or post pay. Once all the required information is obtained, AE will provision the EU for the application.

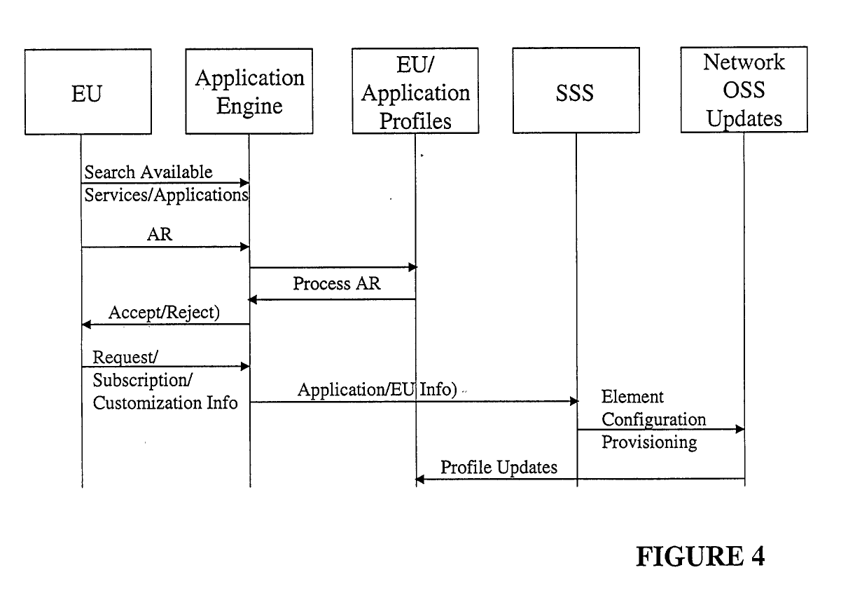

FIG. 4 is a timing diagram depicting the timing relationships between events occurring in a process for controlling the acquisition of services and applications. Generally, it is envisioned that in a typical scenario, an EU searches through the available services/applications. If the EU finds a service/application of interest, the EU sends an AR requesting one or more services/applications. The AR is processed, and information pertaining to the requested services/application is provided to the EU for acceptance or rejection of each requested service/application. Then the EU subscribes to one or more services/applications, and may also customize the subscription request. This information is provided to the SSS to facilitate configuration of the system, such that the requested services/applications may be provided to the EU. Then, if required, EU profiles and/or service/application profiles are appropriately updated.

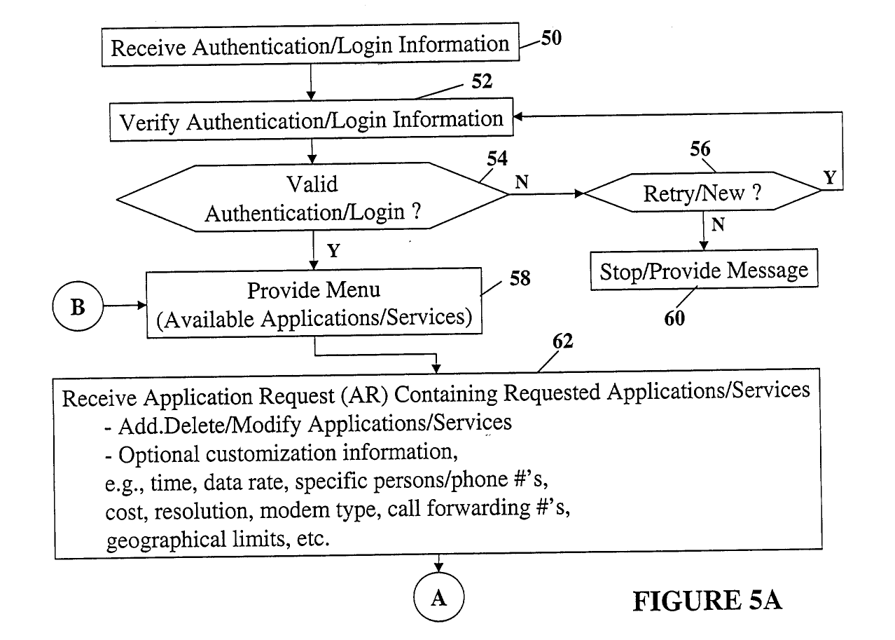

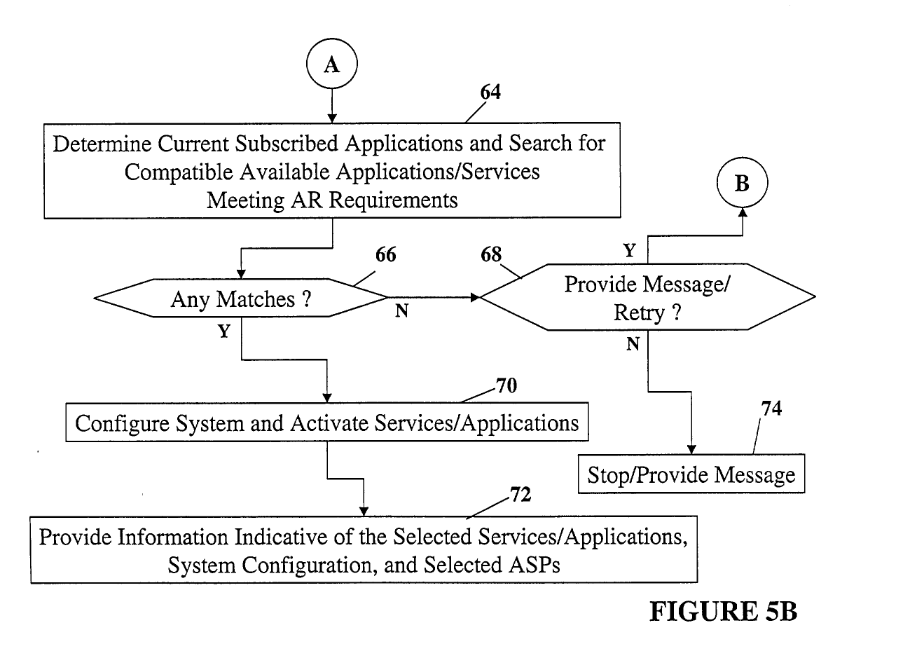

FIGS. 5A and 5B are flow diagrams of an exemplary process for controlling the acquisition of applications and services. As shown in FIG. 5A, authentication/login information is received by the system 100 at step 50. In an exemplary embodiment, an EU may provide authentication/login information via a Web-based user interface (UI) from a Web browser. The system 100 verifies the authentication/login information at step 52. If it is determined that the authentication/login information is not valid at step 54, then the EU is given the opportunity to reenter or create new authentication/login information at step 56. At this point, if the EU decides to retry, the process continues from step 52, otherwise the process is completed at step 60, with an appropriate message being provided to the EU. If it is determined that the authentication/login information is valid (step 54), a customized view of all services/applications to which the EU has previously subscribed is provided at step 58. Also provided at step 58 is a menu (list) of all services/applications available to this EU. At this point, the EU may add, modify, and/or delete subscriptions.

The EU selects services/applications from the list of available services/applications and submits a request for selected service(s)/applications(s). The information indicative of the requested services/applications and associated attributes (customization features) are referred to as an application request (AR). The AR is received by the system 100 at step 62. In an exemplary embodiment, the AR is provided via a Web-based interface in hypertext markup language (HTML) form. During creation of the AR, the EU may select available services/applications, and also customize services/applications as desired. Examples of customization information include the time to provide a service/application, the data rate at which to provide a service/application, specific phone numbers from which to accept collect calls, the total maximum cost limit for all requested services/application provided during a certain time frame, e.g., month, the resolution at which to provide a movie, specific phone numbers to which calls should be forwarded, geographic limitations on acceptance of collect calls. For example, an EU may want to view an online-hosted movie. She may specify that the movie be provided at a specific time during off-peak hours and at a lower resolution to minimize expense. Similarly, the EU may specify the amount that she wants to pay.

An authorized EU may customize an AR in accordance with predefined parameters, e.g., privileges and constraints, assigned to that EU. The predefined parameters are determined, in part, by a selected ASP(s) in accordance with information concerning the requested service/application and system configuration available from the user profiles and service/application profiles contained in the CRM portion 14 and the SCM portion 16, respectively. However, the system 100 provides an authorized EU means for modifying these parameters for specific services/applications. These predefined parameters may be in the form of constraints and/or privileges. For example, constraints associated with a call forwarding feature may include: User A can initiate call forwarding to anywhere in USA, but not to international locations; and User B can forward the calls anywhere, in association with a unified messaging service. Other examples of constraints and privileges include providing an EU with means to automatically accept collect calls from a designated source between 8:00 p.m. and 12:00 p.m. (EU's local time); provide an authentication scheme for third-party charging; modify attributes associated with IP-based applications based on quality of service (QoS), time of day, user and service/application specific attributes; and/or authentication by different methods such as password or speaker verification.

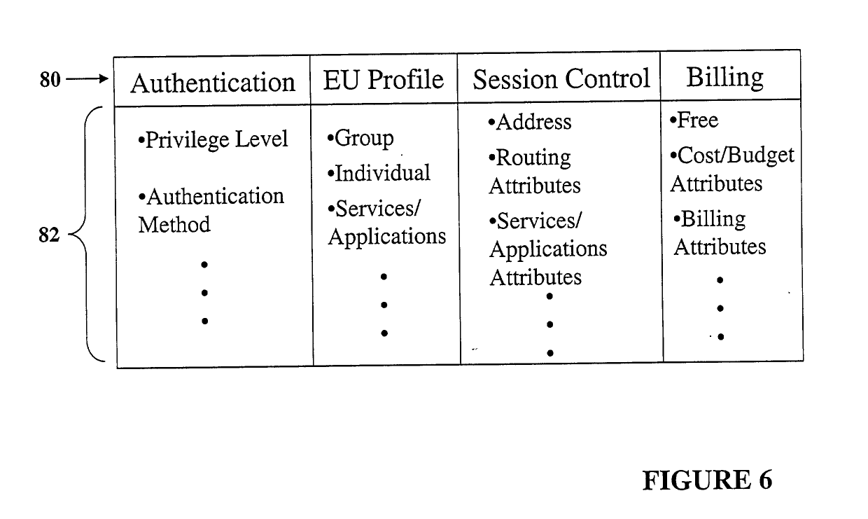

In an exemplary embodiment, customization features may be provided in a two tier object oriented format, wherein the first tier comprises mandatory attributes and the second tier comprises optional attributes within each mandatory attribute, as shown in FIG. 6. Exemplary mandatory attributes are shown in row 80 and associated optional attributes shown in row 82. At least one optional attribute must be selected for each mandatory attribute. For the mandatory attribute of authentication, an EU may select options pertaining to the privilege level and authentication method, or combination thereof. For the mandatory attribute of EU profile, an EU may select optional attributes indicating that the EU is either a group or an individual, or select optional attributes associated with the types of desired services/applications. For the mandatory attribute of session control an EU may select options pertaining to the EU's address, routing attributes, and attributes related to desired services/applications for the particular session. For the mandatory attribute of billing, an EU may select options such as no cost, maximum limit on cost, and other billing attributes. Furthermore, the list of attributes may include the total cost of several attributes and their usage limits to meet specified cost requirement. For example an EU may want to limit the budget for movies and games on a DSL service to $40.00 per month. The system 100 provides the EU means to specify this constraint by storing constraint related information and making it available to authorized ASPs.

Referring to FIG. 5B, the system 100 processes the AR at step 64. Processing the AR includes comparing the requested services/applications, as tailored by the customization information, with available services/applications and the information contained in the EU and service/application profiles. If no matches are found at step 66, an appropriate message and opportunity to retry are provided at step 68. If the EU decides not to retry, the process is halted at step 74. If the EU decides to retry (step 68), the process continues from step 58 (FIG. 5A).

Matches may not be found for any of several reasons, such as the requested service/application is not available at the requested time, resolution, etc. A match may not be found if the EU customer premises equipment (CPE), such as modem type or descrambler are not compatible with the requested service/application. The system 100 also compares the AR with the CPE profile stored in the CRM portion 14 and/or the SCM portion 16. If the requested service/application cannot be fulfilled with the existing CPE setup (as indicated in the CPE profile), the system 100 provides the necessary feedback to the EU. The EU then has the option to subscribe to a new service in accordance with the feedback information. It is advantageous if the requested services/applications are compatible with the EU's CPE capabilities. For example, if the EU chooses a 384 Kb/s Internet access and has only a V.90 modem, the 384 Kb/s type services and/or grade of service requested will not work on a V.90 modem. In an attempt to avoid these types of conflicts, the system 100 provides the appropriate CPE requirements to the EU. The EU may then determine if she has the appropriate equipment before requesting a service/application.

Because it is possible that an EU may request services/application that are similar to services/application to which the EU is currently subscribing, the system 100 also checks for any overlap with existing services/application currently provided to the EU. The system 100 provides information indicative of such a conflict or overlap to the EU. However, the EU is responsible for resolving the conflict/overlap. For example, it is not uncommon for a person to subscribe to multiple Internet access or long distance accounts. The EU is accountable for usage and bill payment. The system 100 provides means for aiding the EU to analyze her profile of services.

If a match is found (step 66), the system 100 is appropriately configured and the selected services/applications are activated at step 70. Upon receiving an AR from an EU, the system 100 compares the AR with service/application profiles in the SCM portion 16 and the user profiles in the CRM portion 14. Once an EU's AR is approved, the system 100 forwards the AR to the SSS portion 22 and the NOS portion 20 to appropriately configure the system 100 for provision of the selected services/applications to the EU. Additionally, the system 100 provides the EU means to enter her network topology and CPE information. This information is stored in a session database, thus providing the EU mans to run services/applications away from the home location.

Information indicative of the selected services/applications, system configuration, and selected ASPs is provided to the EU at step 72. The system 100 provides a confirmation message to the EU if the configuration/activation process succeeds and the selected service/application is ready to run. Otherwise, the system 100 provides a message to the EU indicating the cause for not being able to access the selected service/application and provide suggestions for alternative applications. Once receiving the confirmation message, an EU can access the selected service/application.

A system and method for controlling the acquisition of services and applications as described herein utilizes an integrated, technology independent, approach for providing EUs and ASPs means to control and manage services and applications. This integrated approach combines technologies, such as wireless, wireline, DSL, circuit, and packet, and market segments, such as residential, business, and small office/home office. The system and method provide automated service/application provisioning and activating process. That is, the system automatically configures its elements and communications paths, e.g., interfaces and protocols, to provide selected services/applications to an EU. The system and method also provide an EU means to customize and/or add existing and/or new services/applications. The system and method integrate information contained in the CRM and SCM such that EUs and/or ASPs can easily create, change, and/or delete services/applications without adversely affecting other services/applications. The system and method provide portable access means for an EU to utilize the system from remote locations (portability). That is, an EU may provide network profiles and CPE information pertaining to a remote computer and run applications away from her home location.

The system and method for controlling the acquisition of services and applications as described herein provide many benefits to ASPs. Authorized ASPs have access to EU preferences and information pertaining to how often services/applications are ordered. Authorized ASPs may utilize this information to plan what to offer, purchase in terms of vendor equipment, and increase revenues by offering the right bundles (of services/applications/options) to targeted segments. The system and method provide means for an ASP to offer services/applications having various levels of attributes, such as quality of service (QoS). Services/applications can be new or variations of existing ones. The system and method provide an ASP means to enhance its relationships with EUs by earning trust via selected trials, and demonstration of subscriber experience. This can lead to retaining and gaining new subscribers.

The system and method for controlling the acquisition of services and applications as described herein may be embodied in the form of computer-implemented processes and apparatus for practicing those processes. The system and method for controlling the acquisition of services and applications as described herein may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The system and method for controlling the acquisition of services and applications as described herein may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although illustrated and described with reference to certain specific embodiments, the system and method for controlling the acquisition of services and applications as described herein is nevertheless not intended to be limited to the details shown. Rather, various modifications may be made in the details within the scope and range of equivalents of the claims and without departing from the spirit of the invention.

What is claimed is:

1. A method for controlling acquisition of services, said method comprising the steps of:
receiving a request via a centralized interface for at least one service selected from a plurality of available services comprising communication and media services;
determining a compatibility of said request with said available services; and
providing interface capability to compatible available services.

2. A method in accordance with claim 1, further comprising the step of configuring a system to provide said compatible available services in response to said request and in accordance with said compatible available services.

3. A method in accordance with claim 1, further comprising the step of billing for provided services in a single billing statement.

4. A method in accordance with claim 1, wherein said request is received via one point of access and a compatible service is provided via a point of access selected from a group consisting of said one point of access and another point of access.

5. A method in accordance with claim 1, wherein said request and information indicative of service providers are received via at least a combination of communication means selected from the group consisting of a digital subscriber loop (DSL), a wireless medium, a wireline medium, a dialup modem, a cable modem, and an integrated services digital network (ISDN).

6. A method in accordance with claim 1, further comprising the step of receiving an identification designator for granting permission to accept said request.

7. A method in accordance with claim 1, further comprising the step of receiving an identification designator for granting permission to provide said compatible available services.

8. A method in accordance with claim 1, wherein said step of determining a compatibility comprises determining a compatibility of requested services with equipment used to receive said services.

9. A method in accordance with claim 1, wherein said step of determining a compatibility comprises the step of comparing said requested services with stored information indicative of said available services and stored information indicative of equipment used to receive said services.

10. A method in accordance with claim 1, wherein said services comprise multimedia services, phone services, Internet services, streaming media services, voice communication with others, e-mail, e-commerce, Web browsing, and messaging.

11. A system for controlling acquisition of services, said system comprising:
a customer relations manager portion comprising information indicative of a user profile;
a supply chain manager portion comprising information indicative of available services comprising communications and media services; and
an application engine for receiving a signal indicative of a request for at least one of said services and for processing said request in accordance with information contained in said supply chain manager portion and said customer relations manager portion.

12. A system in accordance with claim 11, further comprising a network operations system portion for facilitating a configuration of said system to accommodate said processing of said request.

13. A system in accordance with claim 11, further comprising a security and authentication portions for verifying access authorization.

14. A system in accordance with claim 11, wherein said system is configured to receive said signal indicative of said request via one point of access and receive a signal indicative of service provider attributes via a point of access selected from the group consisting of said one point of access and another point of access.

15. A system in accordance with claim 11, wherein said system is configured to receive said signal indicative of said request and to receive a signal indicative of service provider attributes via at least a combination of communication means selected from the group consisting of a digital subscriber loop (DSL), a wireless medium, a wireline medium, a dialup modem, a cable modem, and an integrated services digital network (ISDN).

16. A system in accordance claim 11, wherein said services comprise multimedia services, phone services, Internet services, streaming media services, voice communication with others, e-mail, e-commerce, Web browsing, and messaging.

17. A computer readable medium having embodied thereon a program for causing a processor to control acquisition of services, said program readable medium comprising:
means for causing said processor to receive a request via a centralized interface for at least one service selected from a plurality of available services comprising communication and media services;
means for causing said processor to determine a compatibility of said request with said available services; and
means for causing said processor to provide interface capability to compatible available services.

18. A computer readable medium in accordance with claim 17, further comprising:
means for causing said processor to configure a system to provide said compatible available services in response to said request and in accordance with said compatible available services;
means for causing said processor to receive said request via one point of access and provide a compatible service via an access point selected from the group consisting or said one point of access and another point of access; and
means for causing said processor to verify access authorization.

19. A computer readable medium in accordance with claim 17, further comprising:
means for causing said processor to bill for provided services in a single billing statement; and
means for causing said processor to receive said request and information indicative of service providers via at least a combination of communication means selected from the group consisting of a digital subscriber loop (DSL), a wireless medium, a wireline medium, a dialup modem, a cable modem, and an integrated services digital network (ISDN).

20. A computer readable medium in accordance with claim 17, wherein:
said services comprise multimedia services, phone services, Internet services, streaming media services, voice communication with others, e-mail, e-commerce, Web browsing, and messaging; and
said means for determining a compatibility comprises the means for comparing said requested services with stored information indicative of said available services and stored information indicative of equipment used to receive said services.
